(19) United States
(12) Patent Application Publication
(10) Pub. No.: US 2005/0114832 A1
(43) Pub. Date: May 26, 2005

(54) Automatically generating program code from a functional model of software

(75) Inventor: Mitica Manu, Sammamish, WA (US)

Correspondence Address: WOODCOCK WASHBURN LLP, ONE LIBERTY PLACE - 46TH FLOOR, PHILADELPHIA, PA, 19103, US

(73) Assignee: Microsoft Corporation

(21) Appl. No.: 10/720,506

(22) Filed: Nov. 24, 2003

(51) Int. Cl. G06F 9/44

(52) U.S. Cl. 717/106; 717/114

(57) ABSTRACT

Modeling of the code elements and structure of a block of programming code enables code structure and flow to be visualized, eliminating language-specific aspects. One or more programming languages for which code is to be generated are selected. Code in the selected language(s) is generated from the functional model.

### FIELD OF THE INVENTION

The invention relates to computing and in particular to modeling software and automatically generating code in one or more languages from the software model.

### BACKGROUND OF THE INVENTION

Application program interfaces (APIs) are the language and messaging formats that define how programs interact with an operating system, with functions in other programs, with communication systems, or with hardware drivers. For example, an operating system typically provides a set of standard APIs that programmers can use to access common functions such as accepting user input, writing information to the screen, or managing files. Other APIs enable programmers to build programs that easily access operating system features such as pull-down menus, icons, scroll bars, etc. APIs may also interface network services for delivering data across communication systems. Cross-platform APIs provide interfaces for building applications or products that work across multiple operating systems or platforms.

As the use of APIs become more and more widespread, the tasks of API testing and sample generation become larger and larger. To make matters worse, frequently APIs are supported in a number of languages, both managed and unmanaged. In combination with the variation in allowable parameters, the matrix of permutations to be tested may become almost unmanageable. One way to test APIs is to create multiple permutations of test code in multiple target languages to test all the allowable permutations of the API. This is a labor-intensive, repetitive job.

It would be helpful if there were a way to make the testing of APIs easier by functionally modeling test software and automatically generating test code from the model in one or more target languages.

### SUMMARY OF THE INVENTION

Modeling of the code is targeted at the micro-level, for example, at the method body and code element level, enabling the code structure and flow to be quickly visualized while abstracting out language-specific aspects. One or more programming languages for which code is to be generated are selected. Code in the selected language(s) is generated from the functional model. Using the generated code, the compliance of the targeted interface may be verified for each of the languages.

### BRIEF DESCRIPTION OF THE DRAWINGS

The foregoing summary, as well as the following detailed description of illustrative embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a block diagram showing an exemplary computing environment in which aspects of the invention may be implemented;

FIG. 2 is a block diagram of a system for automatically generating code from a functional software model in accordance with one embodiment of the invention;

FIG. 3 is an exemplary block of code for which a functional model is created in accordance with one embodiment of the invention;

FIG. 4 is a graphical representation of a functional model of the block of code illustrated in FIG. 3 in accordance with one embodiment of the invention;

FIG. 5 is a flow diagram of a method for automatically generating code from a functional software model in accordance with one embodiment of the invention; and

FIG. 6a-6e are exemplary user interfaces in accordance with one aspect of the invention.

### DETAILED DESCRIPTION OF ILLUSTRATIVE EMBODIMENTS Overview

Modeling of the code is targeted at the micro-level, for example, at the method body and code element level, enabling the code structure and flow to be quickly visualized while abstracting out language-specific aspects. A user interface may allow desired code elements and structure to be specified. One or more programming languages for which code is to be generated may be selected. Code in the selected language(s) may be generated from the functional model. Using the generated code, the compliance of the targeted interface may be verified for each of the languages.

Exemplary Computing Environment

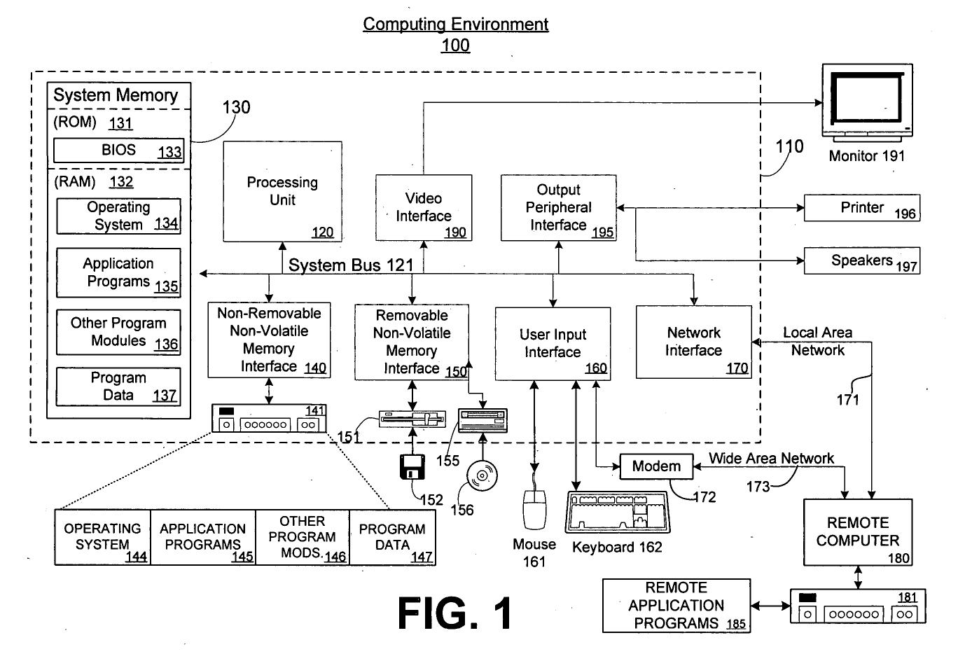

FIG. 1 and the following discussion are intended to provide a brief general description of a suitable computing environment in which the invention may be implemented. It should be understood, however, that handheld, portable, and other computing devices of all kinds are contemplated for use in connection with the present invention. While a general purpose computer is described below, this is but one example, and the present invention requires only a thin client having network server interoperability and interaction. Thus, the present invention may be implemented in an environment of networked hosted services in which very little or minimal client resources are implicated, e.g., a networked environment in which the client device serves merely as a browser or interface to the World Wide Web.

Although not required, the invention can be implemented via an application programming interface (API), for use by a developer, and/or included within the network browsing software which will be described in the general context of computer-executable instructions, such as program modules, being executed by one or more computers, such as client workstations, servers, or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, minicomputers, mainframe computers, and the like. The invention may also be practiced in distributed computing environments where tasks are performed by remote processing devices that are linked through a communications network or other data transmission medium. In a distributed computing environment, program modules may be located in both local and remote computer storage media including memory storage devices.

FIG. 1 thus illustrates an example of a suitable computing system environment 100 in which the invention may be implemented, although as made clear above, the computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100. With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156, such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1 provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB).

A monitor 191 or other type of display device is also connected to the system bus 121 via an interface, such as a video interface 190. A graphics interface 182, such as Northbridge, may also be connected to the system bus 121. Northbridge is a chipset that communicates with the CPU, or host processing unit 120, and assumes responsibility for accelerated graphics port (AGP) communications. One or more graphics processing units (GPUs) 184 may communicate with graphics interface 182. In this regard, GPUs 184 generally include on-chip memory storage, such as register storage and GPUs 184 communicate with a video memory 186. GPUs 184, however, are but one example of a coprocessor and thus a variety of coprocessing devices may be included in computer 110. A monitor 191 or other type of display device is also connected to the system bus 121 via an interface, such as a video interface 190, which may in turn communicate with video memory 186. In addition to monitor 191, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

One of ordinary skill in the art can appreciate that a computer 110 or other client device can be deployed as part of a computer network. In this regard, the present invention pertains to any computer system having any number of memory or storage units, and any number of applications and processes occurring across any number of storage units or volumes. The present invention may apply to an environment with server computers and client computers deployed in a network environment, having remote or local storage. The present invention may also apply to a standalone computing device, having programming language functionality, interpretation and execution capabilities.

Modeling Software Structure and Flow and Automatically Generating Code From the Software Model

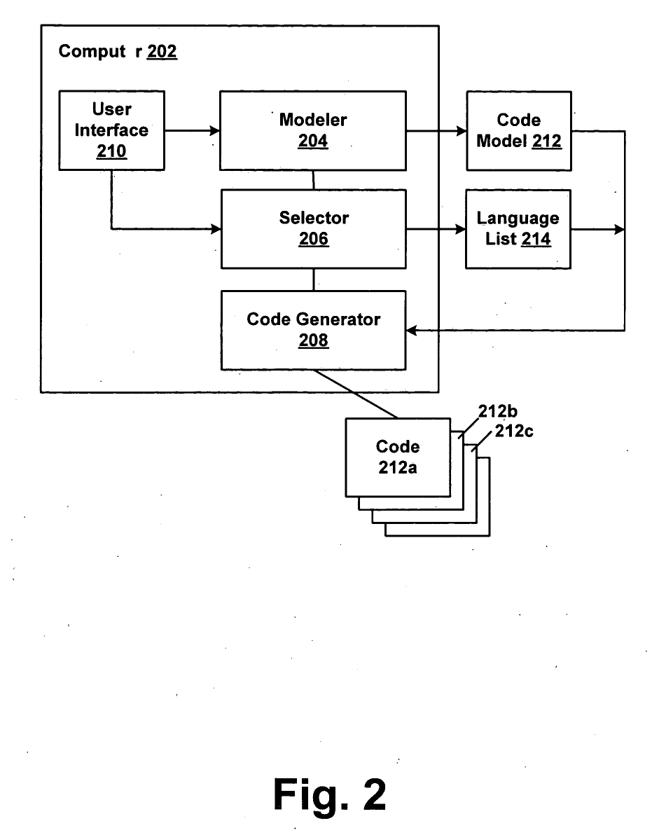

FIG. 2 is a block diagram of an exemplary system for modeling software structure and flow and automatically generating code from the model in accordance with one embodiment of the invention. In FIG. 2, computer 202 may represent a computer such as the one described with respect to FIG. 1, on which the invention may reside.

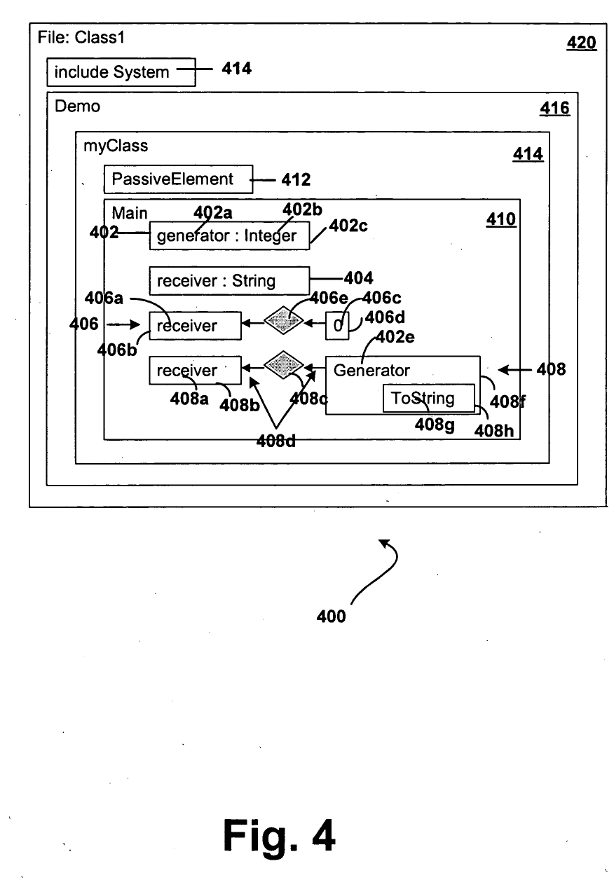

A system in accordance with one embodiment of the invention may include a modeler 204. Modeler 204 in some embodiments accepts input and generates from the input a code model 212, such as the exemplary code model shown in FIG. 4. The system may include a user interface 210 for accepting input to be received by modeler 204. In some embodiments of the invention, the code model 212 generated by modeler 204 is a graphical representation of the structure and flow of a portion of code or a code module.

In some embodiments of the invention, the system may include a selector 206 for generating a list of languages 214 in which code is to be generated. List 214 and model 212 may be input to code generator 208. Code generator 208 may generate one or more code modules 212a, 212b, 212c, etc., in the languages specified in list 214. For example, if C++ and C# were selected (and thus contained in list 214), code 212a may be code generated in C++ and code 212b may be code generated in C#. Code generator 208 may generate one or more modules of code in one or more languages, including but not limited to Ada95, Algol, APL, BASIC, C, C#, C++, Clips, COBOL, Common Lisp, Component Pascal, Concurrent Pascal, Delphi, Eiffel, F#, Forth, FORTRAN, Haskell, Java, JavaScript, (ECMAScript), Jess, Joy, Lisp, M, Mercury, ML, Modula-2, NewtonScript, Oberon, Objective C, Ocaml, Occam2, OPS5, OPS-5, Perl, Perl 5, PHP, Pict, Poplog, PostScript, PowerBuilder, Prolog, Python, Q, Rapira, Ruby, Sather, Scheme, Self, Self, Simula, Smalltalk, TCL, VBScript, VB Script, or VISUAL BASICS. Any number of languages may be listed in list 214 and any number of modules may be generated.

To enable the functional modeling of software structure and flow, in some embodiments of the invention, elements of the desired software are defined. Elements may be defined via an interactive user interface (210). Elements may include but are not limited to: code entities, code relations, evaluation entities, passive entities and block entities.

Code entities, in some embodiments of the invention are defined as the smallest meaningful entity that can exist in a block of code. An example of a code entity may be a variable, comment, constant, object, function, method, prototype, member, data type, callback, delegate, reference, field, variant, property, interface, class, type, enumeration, structure, primitive, array, or event handle.

Code relations, in some embodiments of the invention, are defined as the relationship between two code entities. For example, an assignment operation may be a code relation. Other code relations include but are not limited to +, >, <=, >=, +=, −+, *=, /+,−>, >>, <<, ., %, &, *, |, \, \hat{ }, #, @ and so on.

Evaluation entities may be defined as an execution request of an element that executes or calls a different element from a list of elements. A method call, and a group of 0 to n code entities and 0 to n code relations, and instantiation of a class may be non-limiting examples of an evaluation entity.

A passive entity may be defined as a non-executable piece of code (such as a comment, for example or a modeling diagram for a class, activity or application or a dynamic diagram).

A block entity may be defined as an element that would support 0 to n code entities, code relations, evaluation entities, passive entities or other block entities. Hence, in some embodiments, a block entity may be a method entity, member entity, class entity, namespace entity, project entity, solution entity or file entity.

Graphical representations of code entities, code relations, evaluation entities, passive entities and block entities may be distinguished by use of different shapes in the model or by other visual characteristics such as shading, color, line thickness, line type, inclusion within a box or within a particular size of box or the like. Each visual characteristic may be associated with a set of attributes representing the individual characteristics of the element.

Once all of the elements of the piece of software are defined, a graphical representation of the elements and their relationships (contained by/contained within) may be generated. Alternatively, a graphical representation of the elements and their relationships may be generated as information is entered. The graphical representation may be displayed in a second display area. In some embodiments of the invention, the second display area is displayed adjacent to the user interface. One or more target languages may be selected and the code for that language (or for those languages) may be automatically generated.

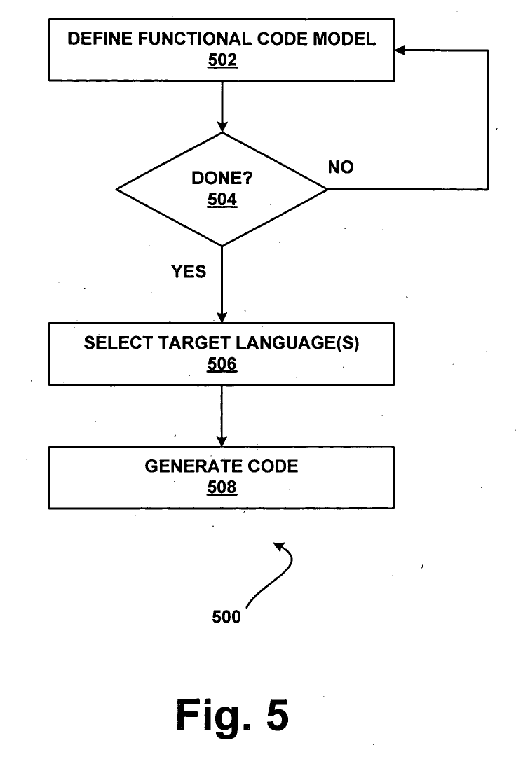

FIG. 5 is a flow diagram of an exemplary method 500 of generating a functional mode of code structure and flow and automatically generating code in one or more specified languages in accordance with one embodiment of the invention. At step 502 the model may be generated. If the model is not complete (504), processing returns to step 502 until the model is complete. (The generation of a graphical model is described in more detail below.) At step 506 a list of target languages may be specified. Alternatively, a default list of target languages may be specified so that a list of target languages does not have to be selected. At step 508 one or more code modules in one or more target languages is generated automatically.

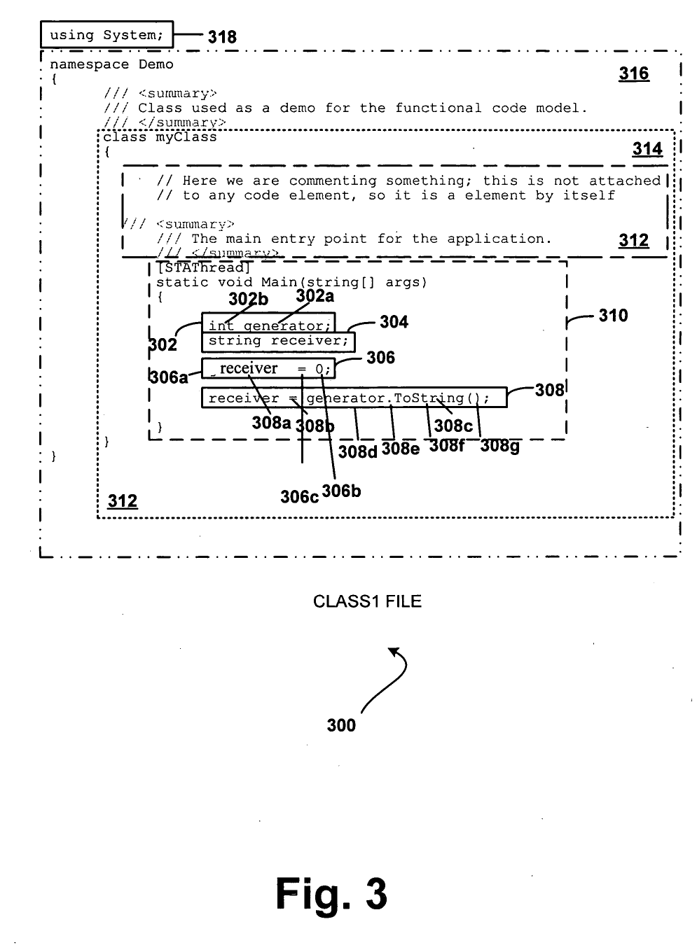

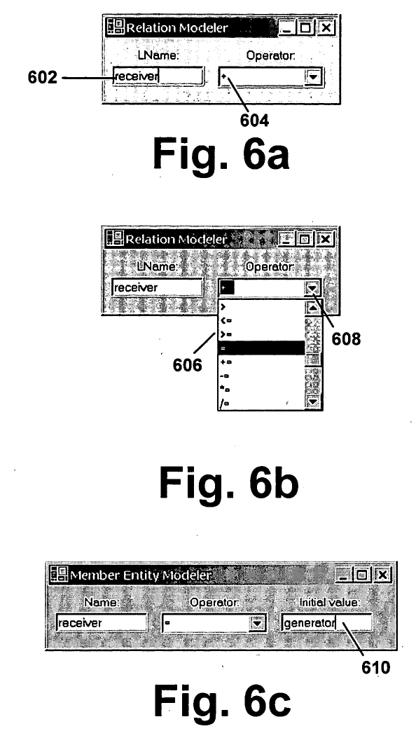

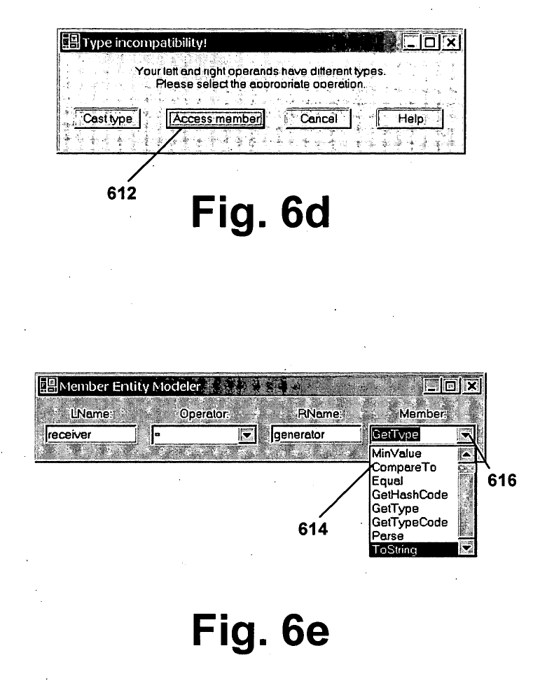

FIG. 3 illustrates an exemplary block of code 300 for which a functional model may be created and FIG. 4 illustrates an exemplary graphical representation (a functional model) of the block of code illustrated in FIG. 3. It will be understood that although for purposes of understanding, in the example that follows, a block of code is the initial starting point from which the functional model is generated, the invention as contemplated is not so limited. For example, a user interface may prompt a user for code elements and the structure of a desired piece of software and the functional model may be created from the information thus collected. Portions of an exemplary user interface are illustrated in FIGS. 6a-6e. Similarly, a block of pseudo code or program code may be input to a parser that generates the information from which the functional model is generated.

Similarly, although the block of code 300 is written in a particular programming language (i.e., C++) it will be understood that the invention as contemplated is not so limited. The block of code from which the functional model is generated may be written in any language. Thus, the functional model may be generated from one or more blocks of code written in any programming language, or may be generated from pseudocode or may be generated from entries made to a user interface.

Referring now to FIG. 3, code block 300 is considered. In some embodiments of the invention, a code block is processed from the innermost element to the outermost element but alternatively, the code block may be processed from the outermost element to the innermost element. Suppose the code block is processed from the innermost element to the outermost element.

The user interface may prompt or allow the modeling of a line of code as follows. Suppose, for example, line 302 is considered. In line 302 (“int generator;”), a code entity, in this case a variable 302a (“generator”) is declared to be of type integer (“int”) 302b. Referring now to FIG. 4, entry 402 may be made in the graphical representation 400. For example, in exemplary graphical representation 400 a code entity (variable “generator” 402a) is declared to be of type integer, denoted by “:integer” 402b and is displayed within a box 402c.

The user interface may prompt or allow additional lines of code to be allowed, (e.g., line 304 (“string receiver;”), line 306 (“receiver=0”), line 308 (“receiver=generator.ToString( ):”) and so on. For example, now suppose that line 304 is considered. In line 304 (“string receiver;”) a variable “receiver” is declared to be of type “string”. As can be seen from FIG. 4, the graphical representation 404 of line 304 is very similar to the graphical representation of line 302.

Line 306 (“generator=0”) contains a first code entity 306a (“generator”), a second code entity 306b (“0”) and an code relation 306c (“=”). Line 306 in some embodiments is displayed as shown in FIG. 4 entry 406. First code entity 306a (“generator”) is displayed as code entity “generator” 406a within box 406b, second code entity 306b (“0”) is displayed as code entity “0” 406c in box 406d and code relation 306c “=” is displayed as code relation 406e (i.e., a diamond shape). Note that because in this case the variable “generator” is being initialized to the value “0”, the arrows point from the right hand operand to the left hand operand (i.e., in the direction of the assignment).

Now suppose that line 308 is modeled. In line 308 “receiver=generator.ToString( );”, “receiver” 308a is a first code entity (a left hand operand), generator.ToStringo” (308c) is a second code entity (a right hand operand) and “=” 308b is a code relation (an assignment operation).

In some embodiments of the invention, a user interface may request or allow identification of a first code entity or left hand operand, as illustrated in exemplary user interface FIG. 6a, reference numeral 602. Suppose “receiver” 308a is entered. Referring now to FIG. 4, entry 408 may be made in the graphical representation 400. For example, in exemplary graphical representation 400, the code entity “receiver” 408a is displayed in a box 408b. The user interface may then request or allow identification of a code relation 604, as illustrated in FIG. 6a. A list of valid operators 606 may be displayed, as illustrated in FIG. 6b by, for example, selecting the down arrow 608. Suppose “=” 308b (assignment) is entered. Entry 408c may be made in the graphical representation 400. In exemplary graphical representation 400, an assignment relation is signified by a diamond shape 408c. The direction of assignment is signified by arrows 408d.

The user interface may then request or allow identification of a second code entity, identification of allowable values for the second code entity (the right hand operand), if the second code entity is an object, if it is an object, what kind of object it is, and if the assignment is a conversion (the type of code entity one is being changed by assignment to code entity two) or a member (code entity one is being assigned the value of a member of code entity two). Suppose, for example, “generator.ToString()” (308c) is entered. Because of the syntax of code entity 308c, (notably in this case, the period 308e and parentheses 308g), the user interface may understand that “generator” 308d is an object, “ToString” 308f a method or function to be performed on object “generator” and the empty parentheses to indicate that no arguments have to be sent to method “ToString” 308f. Alternatively, user interface may receive “generator” 308d as illustrated in exemplary user interface FIG. 6c. and request identification of the type of the right operand 610 (e.g., object, etc.). The type of operation (e.g., cast or member access) may then be requested, as illustrated in FIG. 6d. If, for example, access member 612 is selected, the exemplary user interface FIG. 6e may be displayed, and the list box selections 614 displayed by selecting the down arrow 616. If for example, the type “object” is entered, user interface may request identification of the type of object. In some embodiments of the invention, an object such as exemplary object “generator” 308d is distinguished by displaying object “generator” 408e in a box 408f with method “ToString” 408g in a box 408h within box 408f.

Lines 302, 304, 306 and 308 of code block 300 are included within the function or method “Main” 310. In some embodiments, a method is modeled by including the code entities of the method within a box 410 as shown in FIG. 4.

Passive element 412 may represent comment 312. Comment 312 and Main Method 310 are included within the class entity 314, represented in the model as graphical entity 414. Namespace Demo 316 may be modeled as illustrated in FIG. 4 416. A namespace may span multiple files. Similarly a namespace entity may be contained or included within multiple files so that a many-to-many relationship may exist between files and namespaces.

The various techniques described herein may be implemented in connection with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the creation and/or implementation of domain-specific programming models aspects of the present invention, e.g., through the use of a data processing API or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

While the present invention has been described in connection with the preferred embodiments of the various figures, it is to be understood that other similar embodiments may be used or modifications and additions may be made to the described embodiments for performing the same function of the present invention without deviating therefrom. Similarly it will be understood that although the test framework is described within the context of an automated way of testing software, the invention is not so limited and may be used wherever the scheduling of processes within a standardized format is useful, as for example in the context of business processes. Therefore, the present invention should not be limited to any single embodiment, but rather should be construed in breadth and scope in accordance with the appended claims.

1. A system for automatically generating source code from a functional model comprising:
a modeler for defining at least one of a plurality of code elements and a structure of a code block and generating a graphical representation of the at least one code element and structure of the code block.

2. The system of claim 1, further comprising a user interface for receiving the definition of the at least one code element and the structure of the code block

3. The system of claim 1, further comprising a selector for selecting at least one of a plurality of programming languages in which to generate the source code from the functional model.

4. The system of claim 3, further comprising a code generator for receiving the graphical representation of the at least one code element and the structure of the code block and the at least one programming language and generating source code in each of the at least one programming languages.

5. The system of claim 2, wherein the at least one programming language comprises C++.

6. The system of claim 2, wherein the at leat one programming languages comprises C#.

7. The system of claim 2, wherein the at least one programming languages comprises Visual Basic.

8. A method of automatically generating source code from a functional software model comprising:
defining a plurality of code elements within a block of programming code;
specifying a structure of the block of programming code including the plurality of code elements;
generating from the plurality of code elements and the structure of the block of programming code including the plurality of code elements a graphical representation of the code elements and flow of the block of programming code.

9. The method of claim 8, further comprising a user interface for receiving the definition of the plurality of code elements with the block of programming code and for specifying the structure of the block of programming code.

10. The method of claim 8, further comprising specifying at least one target language in which source code for the graphical representation is to be generated.

11. The method of claim 10, further comprising generating the source code in the at least one target language.

12. The method of claim 8, wherein a one of the plurality of code elements comprises a variable, comment, constant, object, function, method, prototype, member, data type, callback, delegate, reference, field, variant, property, interface, class, type, enumeration, structure, primitive, array, or event handle.

13. The method of claim 8, wherein a one of the plurality of code elements comprises a code relation.

14. The method of claim 13, wherein the code relation comprises a mathematical operator.

15. The method of claim 8, wherein a one of the plurality of code elements comprises an evaluation entity.

16. The method of claim 15, wherein the evaluation entity comprises one of a method call, a plurality of code entities, a plurality of code relations or an instantiation of a class.

17. The method of claim 8, wherein a one of the plurality of code elements comprises a passive entity.

18. The method of claim 15, wherein the passive entity comprises a comment or a modeling diagram.

19. The method of claim 8, wherein a one of the plurality of code elements comprises a block entity.

20. The method of claim 19, wherein the block entity comprises a method entity, a member entity, a class entity a namespace entity or a file entity.

21. The method of claim 20, wherein a many-to-many relationship exists between block entities.

22. A computer-readable medium including computer-readable instructions for defining a plurality of code elements within a block of programming code;
specifying a structure of the block of programming code including the plurality of code elements;
generating from the plurality of code elements and the structure of the block of programming code including the plurality of code elements a graphical representation of the code elements and flow of the block of programming code.
